(19) United States
(12) Patent Application Publication
(10) Pub. No.: US 2007/0022863 A1
(43) Pub. Date: Feb. 1, 2007

(54) Drum damper systems

(76) Inventor: Kevin Ross, Costa Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/495,148

(22) Filed: Jul. 28, 2006

Related U.S. Application Data
(60) Provisional application No. 60/703,554, filed on Jul. 29, 2005.

(51) Int. Cl. G10D 13/02

(52) U.S. Cl. 84/411 M

(57) ABSTRACT

A drum damper for a musical drum comprises a first portion including material having high impact strength and durability suitable for withstanding the forces generated by striking a musical drum. A second portion includes material having sound damping properties suitable for reducing the sound level generated by striking a musical drum.

### RELATED APPLICATIONS

This application is based on and claims the priority of U.S. Provisional Patent Application No. 60/703,554, filed Jul. 29, 2005, titled DRUM DAMPER, which is hereby expressly incorporated by reference herein in its entirety.

### BACKGROUND OF THE INVENTION

1. Field of the Invention

The present invention relates to musical drums and accessories designed to affect the sound, feel and look of musical drums.

2. Description of the Related Art

Musicians may prefer to reduce the amount of sound produced by their instruments in some circumstances. For example, a drummer may wish to limit the sound generated while practicing on musical drums because sound levels which may be appropriate for musical performances may not be appropriate around roommates, neighbors, coworkers, or others in the vicinity. Some drummers have dampened the sound of their drums using drum damper devices.

Some traditional drum damper devices have not been acceptable to drummers. For example, some drum dampers significantly alter the tone and/or feel of the instrument. Some drum dampers reduce the sound too much or too little. Additionally, some drum dampers require disassembling the drum head to apply the drum damper. Some drum dampers are integrated into the drum system such that they are difficult to remove for performances. Some drum dampers are too fragile to endure the repeated impact from drum sticks. Additionally, some drum dampers are not aesthetically appealing.

### SUMMARY OF THE INVENTION

One aspect of the invention includes the realization that typical damping devices for drums either do not significantly reduce the sound level of the drum, or else dampen the sound of a drum so much that they muffle or alter the distinctive tone or sound of the drum. Additionally, some devices require the user to disassemble the drum or otherwise modify the instrument to apply the damping device. Furthermore, some devices are difficult to remove from the drum when damping is not desired. Moreover, some devices are unattractive or distracting to the aesthetic appeal of the drums.

There is a need in the art for a device to decrease the loudness of a drum while generally maintaining the sound clarity and tone quality of the instrument. In one embodiment, a drum damper allows for reduced noise levels, while generally maintaining the feel and sound associated with playing a non-dampened drum.

The ability to practice without unduly disturbing others, while maintaining the distinct sound of a played drum, is advantageous to musicians. Drums are carefully manufactured with specific configurations and materials to produce a desired sound when struck. When practicing, it is sometimes desirable to reduce the level of this sound, while maintaining the distinctive tones the drum was designed to produce.

In one embodiment, a drum damper comprises a sheet of polycarbonate plastic dimensioned to generally cover at least a portion of a drum head.

In another embodiment, a drum damper comprises a sheet of polycarbonate plastic dimensioned to generally cover the top of a drum head. The sheet preferably is configured to be placed on the top of a drum head. The sheet preferably is shaped and configured to resemble the shape and configuration of the drum head. In one embodiment, the sheet has a generally circular shape.

In another embodiment, a drum damper comprises a sheet of polycarbonate plastic dimensioned to generally cover at least a portion of a drum head. The sheet comprises an illustration.

In another embodiment, a drum damper comprises a plurality of layers. At least one layer comprises a durable impact receiving material. A layer may comprise an illustration. A layer may comprise a cushioning material. A layer may comprise a damping material. A layer may comprise a drum head gripping material.

In another embodiment, a drum damper comprises a plurality of layers. At least one layer comprises a polycarbonate material. Another layer comprises a vinyl material.

In another embodiment, a drum damper comprises a first sheet of polycarbonate plastic dimensioned to generally cover the top of a drum head. The first sheet preferably is generally transparent. The damper comprises a second sheet having an image thereon. The second sheet preferably is coupled to the first sheet with an adhesive. The first and second sheets preferably are shaped and configured to resemble the shape and configuration of the drum head. In one embodiment, the first and second sheets have a generally circular shape.

In another embodiment, a drum damper comprises a plurality of sheets coupled together and dimensioned to generally cover the top of a drum head. A first sheet preferably comprises polycarbonate plastic. The first sheet preferably is generally transparent. At least one of the plurality of sheets preferably has an image thereon. The plurality of sheets preferably is coupled with an adhesive. The plurality of sheets preferably are shaped and configured to resemble the shape and configuration of the drum head. In one embodiment, the plurality of sheets has a generally circular shape. The drum damper preferably reduces the loudness of a played drum by between about 5 decibels and about 25 decibels.

In another embodiment, a drum damper comprises a sheet of polycarbonate plastic dimensioned to generally cover a drum head. The sheet preferably has a thickness of about 0.5 mm.

In another embodiment, a drum damper comprises a sheet of polycarbonate plastic dimensioned to generally cover a drum head. The sheet preferably has a thickness of between about 0.2 mm and about 1.2 mm.

In another embodiment, a drum damper comprises a sheet of polycarbonate plastic dimensioned to generally cover a drum head. The sheet preferably reduces the loudness of a played drum by between about 5 decibels and about 25 decibels.

In another embodiment, a drum damper comprises a sheet of polycarbonate plastic dimensioned to generally cover a drum head. The sheet preferably reduces the loudness of a played drum by between about 8 decibels and about 20 decibels.

In another embodiment, a drum damper comprises a sheet of polycarbonate plastic dimensioned to generally cover a drum head. The sheet preferably reduces the loudness of a played drum by between about 10 decibels and about 18 decibels.

In another embodiment, a drum damping system comprises a plurality of drum dampers.

In one application, a method of making a drum damper includes providing a sheet of polycarbonate plastic. The sheet of polycarbonate plastic is dimensioned to generally cover at least a portion of a drum head. In some variations, the method additionally comprises providing an illustration on the sheet of polycarbonate plastic.

In one application, a method of making a drum damper includes providing a sheet of polycarbonate plastic. The sheet of polycarbonate plastic is dimensioned to generally cover at least a portion of a drum head. A plurality of sheets of plastic are coupled to the polycarbonate sheet using an adhesive. In some variations, the method additionally comprises one of the plurality of sheets of plastic having an illustration.

In another application, a method of damping a drum includes providing a drum damper comprising a sheet of polycarbonate plastic dimensioned to generally cover at least a portion of a drum head. The drum damper is placed on a drum head.

In some embodiments, a drum damper comprises a plurality of sheets having different shapes. For example, in some embodiments, the drum damper comprises one or more generally circular sheets. A first generally circular sheet preferably defines a central opening such that the first generally circular sheet forms a ring shape and/or hoop shape. A second generally circular sheet preferably does not define a central opening. The first and second generally circular sheets preferably are coupled together. In some embodiments, the first and second generally circular sheets are coupled with an adhesive. The drum damper preferably has a relatively thicker portion toward an outer portion of the drum damper and a relatively thinner portion toward an inner portion of the drum damper. In some embodiments, a relatively thicker section toward an outer portion of the drum damper preferably provides damping to the drum when played. In some embodiments, a relatively thinner portion toward an inner portion of the drum damper preferably provides suitable response, feel and drum tone when played. In some embodiments, an adhesive layer is provided on one or more surfaces of the drum damper. For example, in some embodiments, an adhesive preferably allows for the drum damper to adhere to the drum head such that the drum damper is held securely to the drum head and yet the drum damper is easily removable and repositionable on the drum head. In some embodiments, the adhesive is washable and reusable. In some embodiments, the drum damper is easily removable from the drum head without damaging the drum head. In some embodiments, the drum damper comprises a non-skid surface material, such as for example a non-skid laminate material.

In some applications, a method of making a drum damper includes providing a sheet of polycarbonate plastic. The sheet of polycarbonate plastic is dimensioned to generally cover at least a portion of a drum head. A plurality of sheets of plastic are coupled to the polycarbonate sheet using an adhesive. In some embodiments, these sheets may have different shapes to provide strong damping regions alongside regions that preserve the natural feel of the drum head. In some variations, the method additionally comprises one of the plurality of sheets of plastic having an illustration. All or part of the drum damper can comprise a design and/or illustration in some embodiments. Some variations include an adhesive to facilitate attachment of the drum damper to the drum head.

In another embodiment, a drum damper comprises a thin base with a raised surface along the edge shaped to fit a drum head.

In another embodiment, a drum damper comprises a thin base with a raised surface along the edge with an illustration.

In another embodiment, a drum damper comprises a thin base shaped to fit a drum head, with a raised surface along the edge and an adhesive element on the bottom.

In another embodiment, a drum damper comprises a thin circular base with a raised surface along the edge and an adhesive element on the bottom.

In some variations, the drum damper is slightly smaller than the drum head. The damper preferably comprises an illustration. The bottom flat portion preferably includes an adhesive element. The sheet preferably has a greater thickness for the raised portion and a lesser thickness for the base portion. The damper preferably reduces the loudness of a played drum by between about 1 decibel and about 50 decibels. The damper preferably reduces the loudness of a played drum by between about 5 decibel and about 25 decibels. The damper preferably reduces the loudness of a played drum by between about 8 decibels and about 20 decibels. The damper preferably reduces the loudness of a played drum by between about 10 decibels and about 18 decibels. The damper preferably comprises a plurality of layers. One layer preferably is polycarbonate plastic layer and the other layer is a vinyl layer. In some embodiments, the damper preferably comprises an illustration confined to the interior portion not covered by the raised edge. In some embodiments, the damper comprises an illustration confined to the outer raised edge of the damper. In some embodiments, the sheet has a shape similar to the drum head. The drum damper preferably comprises at least one layer including a durable impact material. The drum damper preferably includes one or more layers of an adhesive.

According to another application, a method of damping a drum while maintaining tonal quality and feel comprises providing a drum damper including one or more layers selected from the group consisting of an impact resistant layer, a damping layer, a design bearing layer, and an adhesive layer, further comprising positioning the drum damper on a drum head.

According to another application, a method of making a drum damper comprises providing a first sheet of impact resistant material, providing a second sheet of damping material, and coupling the first sheet with the second sheet. According to some variations, one or more of the first and second sheet comprises a design. In some embodiments, the first sheet is configured in the shape of a disk. In some embodiments, the second sheet is configured in a ring shape. In some embodiments the first and second sheet are coupled with an adhesive. In some embodiments, one or more of the first and second sheet comprise an adhesive for releasably securing the drum damper to a drum head.

According to another application, a method of making a drum damper comprises providing a first sheet of material forming a radially thick, axially thin hoop, providing a second sheet of material forming a disc of radius generally equal to the external radius of the hoop, and coupling the first sheet with the second sheet.

According to another embodiment, a drum damper for a musical drum comprises a first portion including material having high impact strength and durability suitable for withstanding the forces generated by striking a musical drum. A second portion includes material having sound damping properties suitable for reducing the sound level generated by striking a musical drum. According to some variations of the embodiment, the drum damper further comprises a third portion including material having gripping properties suitable for removably securing the drum damper to a drum head of a musical drum. The material having high impact strength and durability suitable for withstanding the forces generated by striking a musical drum preferably includes a polycarbonate material. The material having sound damping properties suitable for reducing the sound level generated by striking a musical drum preferably includes a vinyl material. The material having high impact strength and durability suitable for withstanding the forces generated by striking a musical drum preferably includes material suitable for comprising a design. The material having sound damping properties suitable for reducing the sound level generated by striking a musical drum preferably includes material suitable for comprising a design. The first portion including material having high impact strength and durability suitable for withstanding the forces generated by striking a musical drum preferably forms at least a portion of an upper surface of the drum damper. The first portion including material having high impact strength and durability suitable for withstanding the forces generated by striking a musical drum preferably forms at least a portion of a central inner region of the drum damper. The second portion including material having sound damping properties suitable for reducing the sound level generated by striking a musical drum preferably forms at least a portion of a lower surface of the drum damper. The second portion including material having sound damping properties suitable for reducing the sound level generated by striking a musical drum preferably forms at least a portion of a circumferential outer region of the drum damper. The third portion including material having gripping properties suitable for removably securing the drum damper to a drum head of a musical drum preferably includes an adhesive. The first portion preferably includes a first layer and the second portion preferably includes a second layer. The first layer preferably is coupled to the second layer with an adhesive. The first layer is generally shaped as a disk in some embodiments. The second layer is generally shaped as a disk in some embodiments. The second layer is generally shaped as a ring in some embodiments. The drum damper preferably reduces the loudness of a played drum by between about 1 decibel and about 50 decibels in some embodiments. The drum damper preferably reduces the loudness of a played drum by between about 5 decibels and about 30 decibels in some embodiments. In some embodiments, material having sound damping properties suitable for reducing the sound level generated by striking a musical drum preferably includes a cork material. In some embodiments, material having sound damping properties suitable for reducing the sound level generated by striking a musical drum preferably includes a rubber material. In some embodiments, material having sound damping properties suitable for reducing the sound level generated by striking a musical drum preferably includes a composite material. In some embodiments, material having sound damping properties suitable for reducing the sound level generated by striking a musical drum preferably includes a plastic material. In some embodiments, material having sound damping properties suitable for reducing the sound level generated by striking a musical drum preferably includes a foam material.

According to another application, a method of making a drum damper for a musical drum comprises providing a first layer of material having high impact strength and durability suitable for withstanding the forces generated by striking a musical drum. A second layer of material is provided having sound damping properties suitable for reducing the sound level generated by striking a musical drum. The first and second layers are coupled. According to some variations, the method further comprises providing an adhesive on one or more surfaces of one or more of the first and second layers. According to some variations, the method further comprises providing a design on one or more surfaces of one or more of the first and second layers.

### BRIEF DESCRIPTION OF THE DRAWINGS

Further objects, features and advantages of the invention will become apparent from the following detailed description taken in conjunction with the accompanying figures showing illustrative embodiments of the invention.

FIG. 1 shows a set of drums.

FIG. 2 shows one embodiment of a drum damper dimensioned to cover a drumhead of at least one of the drums of the drum set shown in FIG. 1, the drum damper having a relatively small thickness.

FIG. 3 shows the drum damper of FIG. 2 showing the shape of the drum damper.

FIG. 4 shows the drum damper of FIG. 2 and another drum damper, forming a set of drum dampers, shown positioned on the drum set of FIG. 1.

FIG. 5 shows an edge of the drum damper of FIG. 2, the edge showing a first layer and a second layer of the drum damper.

FIG. 6 shows another embodiment of a drum damper having a relatively thicker outer portion and a relatively thinner inner portion.

FIG. 7 shows a cross-sectional view of the drum damper of FIG. 6.

FIG. 8 shows another embodiment of a drum damper having a relatively thicker outer portion and a relatively thinner inner portion.

FIG. 9 shows a cross-sectional view of the drum damper of FIG. 8.

### DETAILED DESCRIPTION OF THE PREFERRED EMBODIMENTS

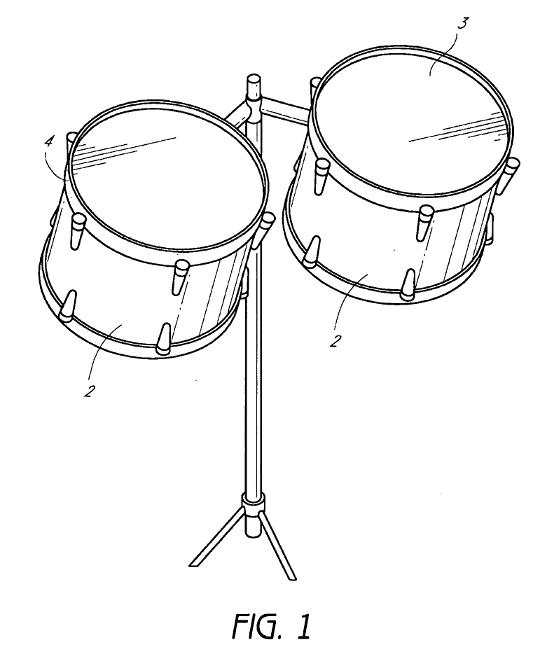

With reference to FIGS. 1, 2, 3 and 4, in one embodiment, a drum damper 1 preferably is sized to approximate a dimension of a drum head 3 of a drum 2. In the illustrated embodiment, the drum damper 1 has a generally circular configuration. Preferably, the drum damper 1 is generally circular in shape and generally sized to cover the entirety of the drum head 3. However, as would be recognized by those skilled in the art, the drum damper 1 can be manufactured in different shapes and sizes while still decreasing the sound level of the drum 2 and generally maintaining the sound clarity and tone quality of the instrument. It will also be recognized by those skilled in the art that the shape of drum damper and the proportion of the drumhead it covers can affect the tonal response of the damped drum, and thus the desired tonal response will largely determine the desired shape and size of the drum head.

In one preferred embodiment, the drum damper 1 comprises a sheet of polycarbonate material. For example, the polycarbonate material can comprise Lexan® PC Resin manufactured by General Electric. Polycarbonate material exhibits high impact strength and durability allowing the drum damper 1 to protect the drum head 3 during practice sessions and withstand the repeated force from being struck by drum sticks. Polycarbonate can be made transparent, translucent, or opaque and in a variety of colors, allowing the drum head 3 to be tailored to the aesthetic desires of the musician. As those skilled in the art will recognize, other materials and plastics may exhibit similar properties and advantages of polycarbonate and can be used in the manufacture of the drum head 3 to decrease the sound level of the drum 2 and generally maintain the sound clarity and tone quality of the instrument. For example, Kevlar, Mylar or other similar materials could be used in some embodiments.

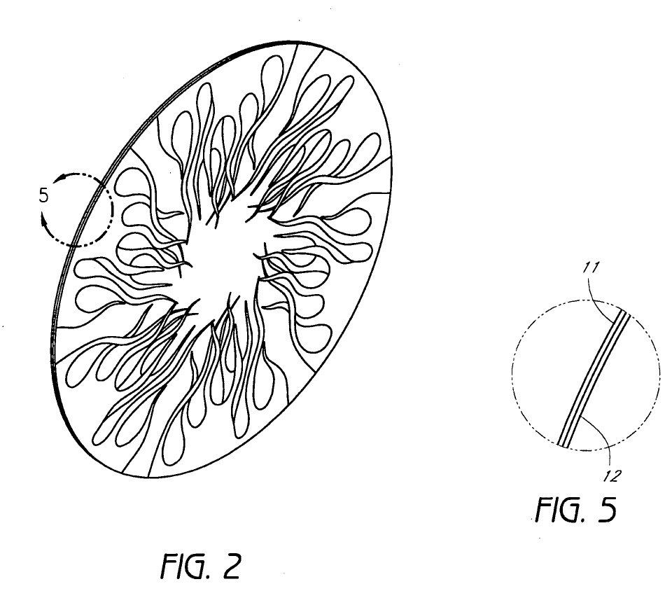

In one preferred embodiment, the drum damper can include one or more designs printed on or coupled to the sheet. For example, a design or image can be printed on a plastic sheet or film 11 and applied to the sheet of polycarbonate material 12, as shown in FIGS. 2 and 5. In FIGS. 2 and 5 the image is printed on a bottom sheet 11 that is applied to the top sheet 12 which can be transparent. In some embodiments, a design or image can be printed on a vinyl material. The vinyl material preferably is thicker and softer than some plastic sheets. The vinyl material can further reduce the sound level, as well as mellow the tone, compared with some plastic sheets. The surface of the vinyl material has more of a rubber texture allowing it to grip the drum head. In one embodiment, the printed sheet can be applied to the polycarbonate sheet and the sheets can be cut out to form a drum damper sized for placement on top of the drum head 3. In one preferred embodiment, vinyl sheets with a thickness less than about 0.5 mm are used for printing. The sheets can be coupled using an adhesive to form the drum damper 1. In one preferred embodiment, the adhesive is a very thin optically clear laminate. The laminate preferably provides bonding of the plastic sheet to the polycarbonate without distorting the graphic. It will be apparent to those skilled in the art that other materials may have desirable properties relating to sound damping, adherence to the drum head, resistance to impact, transparency, and ability to hold a design. It will also be apparent to those skilled in the art that the individual characteristics of the materials in any given layer should largely determine their desired order. It will also be apparent to those skilled in the art that the layers can be combined using methods other than an adhesive, including welding and mechanical means such as stapling, molding, coextrusion, or in any other suitable manner. Additionally in some embodiments, the drum damper can be a uniform material molded or otherwise formed to the desired shape for damping.

The drum damper 1 as shown in FIGS. 2, 3 and 4 has an image of flames attached to the polycarbonate sheet. The design and color of a drum set can be important to musicians. In some embodiments, designs, graphics, illustrations, and the like allow musicians to tailor the drum damper 1 to match the aesthetic design of their drums and allow musicians to select or specify a desired design or image for the drum damper 1. In some embodiments, it may be advantageous to use materials suitable for printing or bearing a design or illustration for manufacturing all or part of the drum damper. A musician may include an illustration of flames as shown in FIGS. 1-4, illustrated characters such as one's name, or any other form of illustration. In some embodiments the drum damper can comprise one or more materials suitable for receiving images or designs. In some embodiments, the drum damper can comprise a design surface that is removable from other layers and or portions of the drum damper. In some embodiments, the design surface is integral with the and or coupled to the other layers and or portions of the drum damper.

In one embodiment, the drum damper comprises a sheet of polycarbonate plastic having a thickness of between about 0.2 mm and about 1.2 mm. In some embodiments, the thickness preferably is about 0.5 mm. In general, the thicker the polycarbonate sheet the greater the corresponding decrease in loudness. It will additionally be apparent to those skilled in the art that a thicker sheet will be more resistant to repeated impact, but will also have a greater effect on the tonal response of the drum head. In some embodiments, the polycarbonate sheet is thinner and another layer, such as for example, the vinyl layer is thicker to provide increased damping of the instrument.

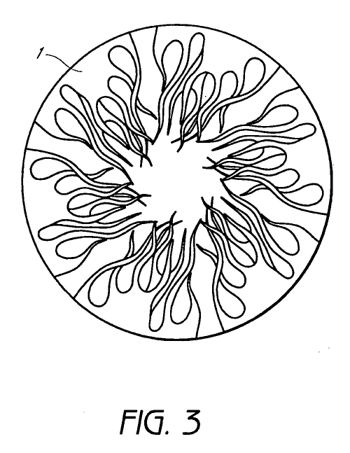

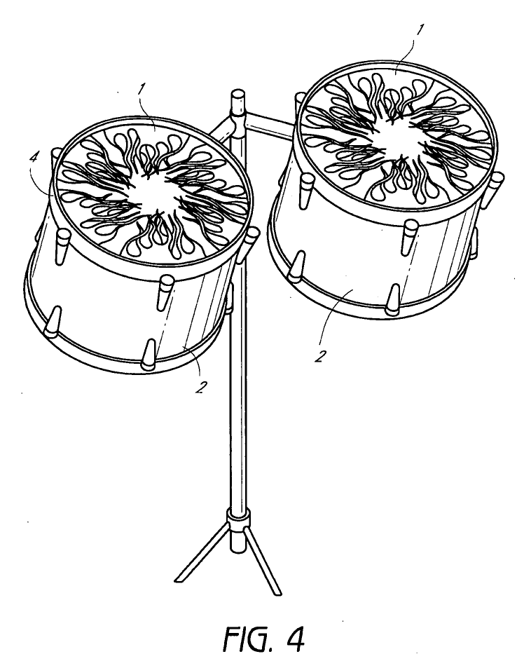

The drum damper 1 is shown in FIGS. 2 and 3. In some embodiments, the drum damper 1 is dimensioned to generally fit the top of the drum head 3 of FIG. 1. When placed on the drum head 3, the outer edge of the drum damper 1 preferably is in close proximity to an outer edge 4 of the drum head 3. When placed in close proximity to an outer edge 4 of the drum head 3, the drum damper 1 is able to stay positioned on the drum 2 without the use of adhesives. For example, in the illustrated embodiment, the drum damper 1 preferably substantially covers the drum head 3. In other embodiments, the drum damper can be sized and configured to cover less than substantially all of the drum head 3. FIG. 4 shows the drum damper device lying on the top of the drum head 3. When the drum head is struck with the drum damper 1 positioned thereon, the drum 2 preferably generally maintains its distinctive sound at a decreased decibel level.

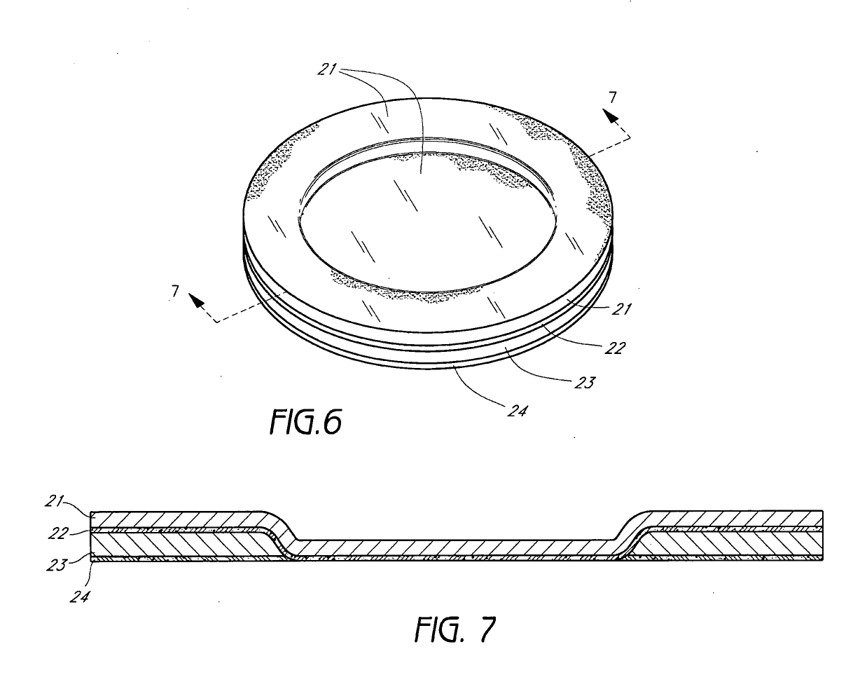

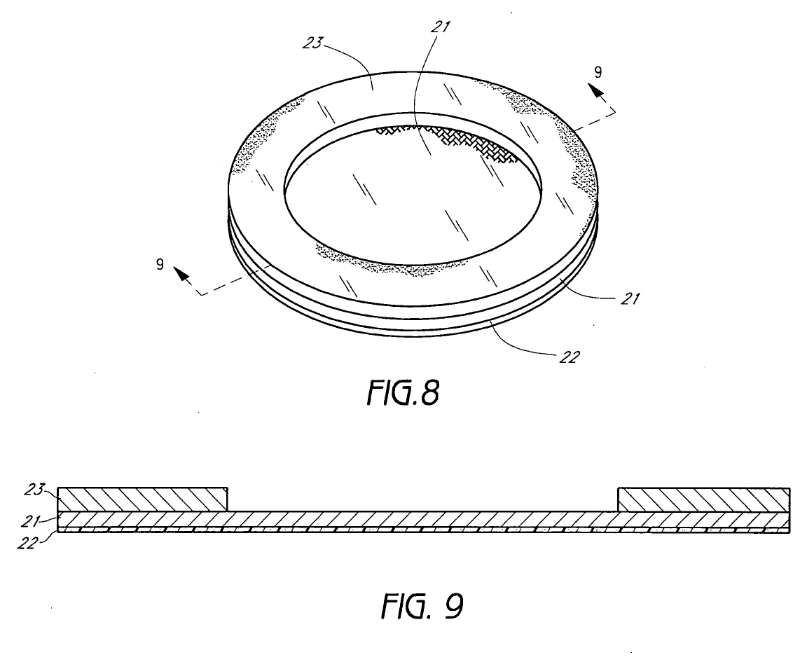

In some preferred embodiments, the drum damper is thicker near the edge and thinner near the middle, as shown in FIGS. 6-9. According to one method, one or more of the embodiments illustrated can be manufactured by laying one or more full disc layers 21 over one or more hoop shaped layers 23. The thicker outer portion in some embodiments effectively dampens the sound of the drum 2, while the thinner inner portion of the drum allows the drummer to play without significantly altering the quality or characteristics of the tone and the feel of the drum head 3. In some embodiments, thicker damping material is positioned toward the outside of the drum damper 1, leaving a thin layer toward the center that minimizes differences between the feel of an uncovered drum head and the drum damper. In some embodiments, the layers of material can be coupled using an adhesive, a pressing process, a heating process, a sealing process, or other suitable methods for coupling the layers.

In some embodiments, one benefit of the full disc portion 21 is that it allows a design to be provided in the center of the covered drum head 3. It will be apparent to one skilled in the art that the hoop portion 23 can potentially be provided above or below the full disc portion 21, as shown in FIGS. 6-9, or they can alternate in any order serving the properties desired. It will also be apparent that one could provide hoops with holes of varying sizes or construct a drum damper 1 with an opening in the center. It will also be apparent that one could generate some of the same effects by providing a drum damper comprised of one continuous material of the same total shape as any of the shapes shown in FIGS. 6-9. For example a single layer could be molded or formed having an outer thicker layer and an inner thinner layer to increase damping, maintain tone quality and feel, and carry a design or illustration to enhance the aesthetics of the drum damper and drum set. In some embodiments, one or more layers can have material removed from portions of the layer. For example cut-outs in the damping layer or the impact layer could be provided for aesthetic purposes and/or to provide a drum damper with a different level of damping ability.

In some embodiments, the drum damper 1 may include an adhesive 22 not only joining the individual layers 21 and 23, but also to further improve adherence to the drum head 3, as shown in FIGS. 7 and 9. In some embodiments, not every layer will span the entire drum head 3. Accordingly, a given layer of adhesive 22 could serve to both adhere individual layers of the drum damper 1 to each other, and to adhere the drum damper 1 to the drum head 3, as shown in FIG. 7. In some embodiments, the adhesive 22 preferably is not so strong as to permanently attach the drum damper 1 to the drum head 3, or so as to damage the drum head 3 upon removal of the drum damper 1. However, as will be apparent to those skilled in the art, in some embodiments, a more permanent attachment of the drum damper 1 to the drum head 3 may be desirable in some situations. It will also be apparent to those skilled in the art that other methods for attaching or coupling the drum damper to the drum head can also be used. Fore example, in some embodiments a non-skid material can be used. In some embodiments, the characteristics of one or more of the layers of the drum damper provide sufficient grip to the drum head that an adhesive need not be used to attach the drum damper to the drum head. In embodiments other attachment methods or devices could be used, such as for example tape materials, spray-on materials, pressure sensitive materials, or other materials. It should be noted that not all adhesive layers are necessarily depicted in the figures; for example, in FIG. 9, the full disc layer is preferably adhered to the hoop layer with an adhesive. In some embodiment other suitable methods for joining the layers can be used.

In some embodiments, the drum damper 1 decreases the decibel level of a played drum by between about 1 decibel and about 50 decibels. In some embodiments, the drum damper 1 decreases the decibel level of a played drum by between about 5 decibels and about 30 decibels. In some embodiments, the drum damper 1 decreases the decibel level of a played drum by between about 15 decibels and about 50 decibels. In some embodiments, the drum damper 1 decreases the decibel level of a played drum by between about 10 decibels and about 35 decibels. In some embodiments, the drum damper 1 decreases the decibel level of a played drum by between about 5 decibels and about 25 decibels. In some embodiments, the drum damper 1 decreases the decibel level by between about 8 decibels and about 20 decibels. In some embodiments, the drum damper 1 decreases the decibel level by between about 10 decibels and about 18 decibels. In some embodiments, the drum damper decreases the decibel level of a played drum by less than about 5 decibels. In some embodiments, the drum damper decreases the decibel level of a played drum by less than about 8 decibels. In some embodiments, the drum damper decreases the decibel level of a played drum by less than about 10 decibels. In some embodiments, the drum damper decreases the decibel level of a played drum by more than about 25 decibels. In some embodiments, the drum damper decreases the decibel level of a played drum by more than about 20 decibels. In some embodiments, the drum damper decreases the decibel level of a played drum by more than about 18 decibels. Generally, a decrease in noise level by about 10 decibels is perceived by the human ear as being about half as loud. Thus, in some embodiments, the perceived noise level can be significantly reduced while maintaining the distinctive sound clarity and tonal quality of the drum.

Generally, a drum damper having a relatively thicker polycarbonate sheet decreases the loudness of the played drum more than a drum damper having a relatively thinner polycarbonate sheet. Additionally, by increasing the thickness of the printed sheet, or other layers, attached to the polycarbonate sheet, the loudness of the drum is decreased, while maintaining the distinct tone and clarity of the drum. For example, increasing the thickness of a vinyl layer coupled to a polycarbonate layer can reduce loudness while generally maintaining tone quality.

In some embodiments, a plurality of drum dampers can be constructed having different thicknesses. In some embodiments, a set of drum dampers can be constructed having similar thicknesses. Normally, musicians have a variety of different drum sizes in their drum set. In one embodiment, a plurality of drum dampers is provided to cover a plurality of drums having different size drumheads. The drum dampers 1 can be packaged in configurations to match the size of a basic drum set or packaged separately to allow musicians to have dampers for their unique drum sets.

In one method, a drum damper comprising a sheet of polycarbonate material is provided. The drum damper preferably is generally circular in shape and of a diameter generally equal to a drum head. The drum damper preferably is placed on the top of the drum head. As the instrument is played, the drum damper decreases the loudness of the drum while generally maintaining the sound clarity and tone quality of the instrument.

In one preferred method, a layer of polycarbonate material is coupled with a layer including an image or design. The image or design can be printed directly onto the polycarbonate material, or printed onto another sheet that is coupled to the polycarbonate sheet. In one preferred method, the image is printed on a vinyl plastic sheet and the sheet is then coupled to the polycarbonate sheet. In some embodiments, an adhesive, preferably a thin optically clear laminate, can be used to couple the sheets. The polycarbonate material is generally circular in shape but can be constructed in other sizes and shapes while still decreasing the loudness and maintaining the sound clarity and tone quality of the instrument. It will be apparent to those skilled in the art that the individual joined sheets need not all have the same size and shape. In one preferred application of this method, one joined sheet has a hoop shape while another joined sheet provides a full disc.

According to one application, the drum damper is placed on the drum head without the use of any attachment mechanism. In other applications, an attachment mechanism can be provided to secure the drum damper to the drum head. Preferably, while practicing the musician will position the drum dampers on one or more drum heads to allow for decreased loudness while maintaining the sound clarity and tone quality of the instrument. When the musician can practice without decreasing the loudness of the drums, or needs to perform, the drum dampers can easily be removed from the drum head.

The various devices, methods and techniques described above provide a number of ways to carry out the invention. Of course, it is to be understood that not necessarily all objectives or advantages described may be achieved in accordance with any particular embodiment described herein. Also, although the invention has been disclosed in the context of certain embodiments and examples, it will be understood by those skilled in the art that the invention extends beyond the specifically disclosed embodiments to other alternative embodiments and/or uses and obvious modifications and equivalents there of. Accordingly, the invention is not intended to be limited by the specific disclosures of the preferred embodiments herein.

What is claimed is:

1. A drum damper for a musical drum, comprising:
a first portion including material having high impact strength and durability suitable for withstanding the forces generated by striking a musical drum; and
a second portion including material having sound damping properties suitable for reducing the sound level generated by striking a musical drum.

2. The drum damper of claim 1, further comprising a third portion including material having gripping properties suitable for removably securing the drum damper to a drum head of a musical drum.

3. The drum damper of claim 1, wherein the material having high impact strength and durability suitable for withstanding the forces generated by striking a musical drum includes a polycarbonate material.

4. The drum damper of claim 1, wherein the material having sound damping properties suitable for reducing the sound level generated by striking a musical drum includes a vinyl material.

5. The drum damper of claim 1, wherein the material having high impact strength and durability suitable for withstanding the forces generated by striking a musical drum includes material suitable for comprising a design.

6. The drum damper of claim 1, wherein the material having sound damping properties suitable for reducing the sound level generated by striking a musical drum includes material suitable for comprising a design.

7. The drum damper of claim 1, wherein the first portion including material having high impact strength and durability suitable for withstanding the forces generated by striking a musical drum forms at least a portion of an upper surface of the drum damper.

8. The drum damper of claim 1, wherein the first portion including material having high impact strength and durability suitable for withstanding the forces generated by striking a musical drum forms at least a portion of a central inner region of the drum damper.

9. The drum damper of claim 1, wherein the second portion including material having sound damping properties suitable for reducing the sound level generated by striking a musical drum forms at least a portion of a lower surface of the drum damper.

10. The drum damper of claim 1, wherein the second portion including material having sound damping properties suitable for reducing the sound level generated by striking a musical drum forms at least a portion of a circumferential outer region of the drum damper.

11. The drum damper of claim 1, wherein the third portion including material having gripping properties suitable for removably securing the drum damper to a drum head of a musical drum includes an adhesive.

12. The drum damper of claim 1, wherein the first portion includes a first layer and the second portion includes a second layer, wherein the first layer is coupled to the second layer.

13. The drum damper of claim 12, wherein the first layer is generally shaped as a disk.

14. The drum damper of claim 12, wherein the second layer is generally shaped as a disk.

15. The drum damper of claim 12, wherein the second layer is generally shaped as a ring.

16. The drum damper of claim 1, wherein the drum damper reduces the loudness of a played drum by between about 1 decibel and about 50 decibels.

17. The drum damper of claim 1, wherein the drum damper reduces the loudness of a played drum by between about 5 decibels and about 30 decibels.

18. The method of making a drum damper for a musical drum, comprising:
providing a first layer of material having high impact strength and durability suitable for withstanding the forces generated by striking a musical drum;
providing a second layer of material having sound damping properties suitable for reducing the sound level generated by striking a musical drum; and
coupling the first and second layers.

19. The method of claim 18, further comprising providing an adhesive on one or more surfaces of one or more of the first and second layers.

20. The method of claim 18, further comprising providing a design on one or more surfaces of one or more of the first and second layers.
